(19) United States
(12) Patent Application Publication
(10) Pub. No.: US 2020/0216009 A1
(43) Pub. Date: Jul. 9, 2020

(54) Flexi Aerius

(71) Applicant: Crystal Sylver, San Francisco, CA (US)

(72) Inventor: Crystal Sylver, San Francisco, CA (US)

(21) Appl. No.: 16/243,910

(22) Filed: Jan. 9, 2019

(51) Int. Cl. B60R 21/235; B60R 21/231

(52) U.S. Cl. CPC B60R 21/235; B60R 2021/23542; B60R 2021/23514; B60R 21/231

(57) ABSTRACT

The invention is a flexible airbag.

### BACKGROUND OF INVENTION

The Flexi Aerius is a manufactured article. It is a seamless airbag made with a light stretch front panel, which is flat rather than convex.

Traditional airbags are made of several smaller pieces of non-stretch fabric that are sewn together to create a larger bag. When expanded the airbag is very hard and round. It forcefully pushes into drivers and passengers, and can cause serious injury and death. Traditional airbags have a higher probability of exploding or tearing. Smaller people and children are at high risk of injuries and death due to the impact current airbags make on the body.

### BRIEF SUMMARY OF INVENTION

The Flexi Aerius is a seamless airbag made of high quality fabric. It uses a Teflon coated material for the sides and back, which is impenetrable by most glass and sharp objects. The Teflon fabric seamlessly weaves into another fabric, which utilizes a light stretch material that cannot break, such as spandex, latex, or rubber. This creates a seamless flat front panel with soft rounded corners. The flat front panel allows for a natural bounce back like a pillow rather than a hard forceful punch that a round non-stretch airbag creates. It is shaped into a rectangle rather than a circle to provide more surface area. This is an improved safety feature for the automobile industry.

### BRIEF DESCRIPTION OF THE SEVERAL VIEWS OF THE DRAWING

1/1

FIG. 1—Front view of driver side Flexi Aerius airbag fully expanded,

FIG. 2—Top view of driver side Flexi Aerius airbag fully expanded

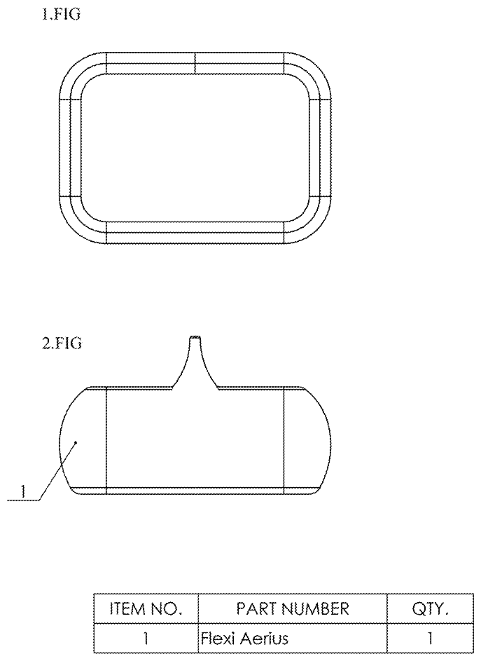

1. Flexi Aerius

(1) Flexi Aerius airbag fully expanded.

### DETAILED DESCRIPTION OF THE INVENTION

The invention is made of one continuous seamless weave fabric, which transitions from a stretch to a woven material, creating a flexible airbag. The back and sides are coated in Teflon and the front panel is a light stretch material using spandex, latex, or rubber, which allows for a natural bounce back when fully expanded. It is safer for smaller people and children. It is designed not to explode or tear because it has a natural stretch and seamless construction. The front panel is flat rather than convex for added safety. The airbag creates a pillow like atmosphere and cushion to protect drivers and passengers from major bodily harm in case of an accident. The airbag can be custom designed for driver and passenger sides and for any make and model vehicles.

The invention is made similar to a traditional airbag in a manufacturing facility, except it uses one seamless fabric piece rather than several small pieces that are sewn together. It is held in place similar to a traditional airbag and uses compressed gas canisters to expand when an accident occurs, helping to reduce serious injury and death.

The invention can be used for drivers, passengers, front, sides, roof, middle, and anywhere an airbag can be placed. It can also be used in mopeds and motorcycles.

The Flexi Aerius improves upon the current model of automobile airbag, reducing serious injury and death due to airbag deployment. The Flexi Aerius airbag provides a flat front panel using a light stretch fabric, which does not create a hard surface that can cause injury. It provides a cushion with a bounce back, protecting fragile bones, muscles, and tissue in individuals. It is shaped like a rounded rectangle to allow protection for chest, face, shoulders, and arms.

The gas canisters may be filled below full expansion levels in order to prevent full and exploding airbags. The airbags may be connected to pressure sensors for adequate expansion, without over-expansion for smaller people and children, or passengers slumped over the steering wheel.

1. The invention claimed is a Flexi Aerius comprised of:
a seamless weaved fabric creating a soft rectangle with rounded corners;
a flat front panel made of a seamless stretch fabric using latex, rubber, or spandex;
a Teflon coat on the sides and back.
Dependent Claims

2. The Flexi Aerius as recited in claim 1, may use several sewn panels rather than one seamless piece.

3. The Flexi Aerius as recited in claim 1, may use any variation of stretch fabric, including spandex, latex, rubber, or other.

4. The Flexi Aerius as recited in claim 1, may use a Teflon coating on the back and sides or it may not use Teflon on the back and sides.

5. The Flexi Aerius as recited in claim 1, may use pressure sensors for accurate expansion levels.

6. The Flexi Aerius as recited in claim 1, may be designed for driver side, passenger side, roof, middle, backseats, and anywhere an airbag may go.

7. The Flexi Aerius as recited in claim 1, may be designed for any make or model automobile, big-rig, or biped.

8. The Flexi Aerius as recited in claim 1, may use any variety of fabric.
